(19) United States
(12) Patent Application Publication
(10) Pub. No.: US 2008/0157492 A1
(43) Pub. Date: Jul. 3, 2008

(54) Transformable creeper

(76) Inventors: Arthur Chaykin, Leawood, KS (US); Peter Gillespie, Kansas City, MO (US)

Correspondence Address: LATHROP & GAGE LC, 2345 GRAND AVENUE, SUITE 2800, KANSAS CITY, MO, 64108, US

(21) Appl. No.: 11/647,859

(22) Filed: Dec. 29, 2006

(51) Int. Cl. B25H 5/00

(52) U.S. Cl. 280/32.6

(57) ABSTRACT

A transformable creeper has a movable frame that facilitates movement between an extended position and a seat position, as well as a storage position, and can support the human operator when lying and seated on the creeper. The creeper is of two pieces, that fold over each other tightly, so as to occupy minimal storage space. The creeper also includes a member that is pivotally mounted to the frame to function as a seat, that is easily accessible, when the frame is in the seat position and seating is desired.

### TECHNICAL FIELD

The disclosed subject matter relates to creepers, typically used by mechanics to slide under vehicles and the like, and in particular, to creepers that are transformable, between an extended position, where an operator is supported in a lying position, a seat position, where the operator is supported in a sitting position, and a storage position.

### BACKGROUND

Creepers have long been used by automotive mechanics and the like, to allow them access to locations under a vehicle, while supporting them in a lying position so they can work at the particular under-vehicle location. Additionally, many times, in order to complete a job, the mechanic must alternate between lying, sitting and standing positions.

Numerous creepers have been proposed, that are transformable between lying supports and seated supports. However, all of these creepers exhibit substantial drawbacks.

Initially, many of these contemporary transformable creepers are in three pieces, and as such, require time to transform. These three-piece creepers include a middle piece or interlocking connector, that when the creepers are folded, makes them bulky to store, as the interlocking connector adds volume to the storage orientation. Additionally, when transformed so as to provide a seat, the transformation is complicated, as various pins, and latches must be manipulated simultaneously, and in many cases with sufficient strength, making the transformation complicated. Additional hinges and components associated with these conventional three-piece creepers make them more expensive and difficult to manufacture.

Contemporary creepers also include two-piece creepers, but these creepers require an external frame structure, that remains as the base of the creeper. By having this base, the manufacturing costs and bulk of the creeper is increased. Moreover, on most contemporary creepers, the seat is supported on a base frame, typically parallel to the ground surface, at four points, corresponding to four legs for the seat.

### SUMMARY

The disclosed subject matter improves on the contemporary art by providing a transformable creeper that is simple to transform and move between the extended position and the seat position, as well as a storage position, and sturdy to support a human operator when both lying and seated on the creeper. The creeper is simple to construct, as it is of two pieces, that fold over each other tightly, in a compact manner, so as to occupy minimal storage space. There is a seat portion, that is easily accessible, as it is pivotally mounted to the frame, and supported in a cantilevered manner, when operating as a seat for the operator, when the creeper is in the seat position. The seat portion can be rotated inward, back into the frame, when seating is finished. Movement of the seat, as well as movement of the pieces that form the movable frame is simple, and requires minimal strength.

An embodiment of the disclosed subject matter is directed to a transformable creeper. The creeper includes a frame including a first portion and a second portion. The first portion and the second portion are joined together for being rotatable with respect to each other, and rotatable between a first position, where the first portion and the second portion are typically coplanar to each other, a second position, where the first portion and second portion are typically perpendicular to each other, and a third position, where the first portion and the second portion are typically parallel to each other. There is a support surface joined to the first portion of the frame. There is another support surface joined to the second portion of the frame, this support surface being movable outward from the second portion to define a seat for supporting an operator, when the frame is in the second position.

Another embodiment of the disclosed subject matter is directed to a two-piece transformable creeper. The creeper has a first piece defining a base, and a second piece, that includes a movable portion that is movable into at least one orientation defining a seat. The first piece and the second piece are rotatably mounted with respect to each other, and movable between a first position, where the first piece and the second piece are typically coplanar to each other, and a second position, where the first piece and the second piece are typically perpendicular to each other. The second position is such that the movable portion is movable into an orientation defining a seat.

Another embodiment of the disclosed subject matter is directed to a transformable creeper of a first piece and a second piece. The first piece defines a base. The second piece includes a movable portion that is movable into at least one orientation defining a seat. The first piece and the second piece are rotatably mounted with respect to each other, and movable between at least one operative position and a storage position, where the first piece is typically parallel to the second piece.

Another embodiment of the disclosed subject matter is directed to a method for operating a transformable creeper. The method includes providing a transformable creeper. The creeper has a first piece defining a base, and, a second piece, including a movable portion, that is movable into at least one orientation defining a seat. The first piece and the second piece are rotatably mounted with respect to each other, and movable between a first position, where the first piece and the second piece are typically coplanar to each other, and a second position, where the first piece and the second piece are typically perpendicular to each other. The first piece and the second piece are then moved into a typically coplanar orientation with respect to each other, such that the creeper is in the first position.

Another embodiment of the disclosed subject matter is directed to a method for operating a transformable two-piece creeper. The method includes providing a transformable creeper including, a first piece defining a base, and, a second piece including a movable portion that is movable into an orientation defining a seat. The first piece and the second piece are rotatably mounted with respect to each other, and movable between one or more operative positions, for example, an extended position, where an operator is supported in a lying position, and a seat position, where the operator is supported in a seated position, and a storage position, where the first piece is typically parallel to the second piece. The second piece is then moved with respect to the first piece between the storage position and one operative position.

### BRIEF DESCRIPTION OF THE DRAWINGS

Attention is now directed to the drawings, where like reference numerals or characters indicate corresponding or like components. In the drawings:

FIG. 1 is a perspective view of an apparatus in a first or extended position;

FIGS. 2A and 2B are cross-sectional views of the spring loaded pins of the locking structure;

FIGS. 3A-3C are perspective views of the locking structure for the frame of the apparatus;

FIG. 4 is a perspective view of the apparatus in a second or seat position;

FIGS. 5A and 5B are detailed perspective views of the seat when the apparatus is in the second or seat position; and,

FIG. 6 is a perspective view of the apparatus in a third or storage position.

### DETAILED DESCRIPTION OF THE DRAWINGS

In this document, references are made to directions, such as upper, lower, top, bottom, up, down, upward, downward, clockwise, counterclockwise, etc. These directional references are exemplary, to show the disclosed subject matter in a typical orientation, and are in no way limiting.

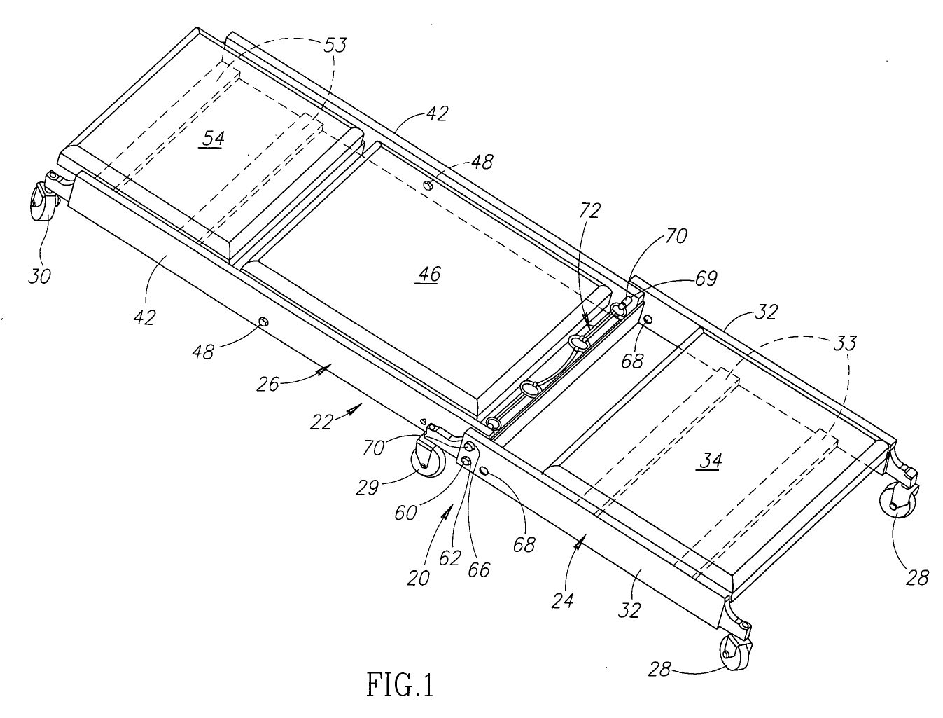

FIG. 1 shows the apparatus 20, that includes a frame 22, formed of a base portion 24 and a seat portion 26. The base portion 24 and the seat portion 26, are movable, typically rotatable, with respect to each other, between operative positions, and a storage position, as detailed below. The frame 22, is shown in an operative position, otherwise referred to as a first or extended position, with its base portion 24 and seat portion 26 in a substantially coplanar orientation with respect to each other. In this position, the apparatus 20 can support an operator (a human) in a lying or reclining position.

The base portion 24 typically includes paired wheels 28, 29, for example, castor wheels, that provide multidirectional mobility for the operator. The seat portion 26 typically includes a single pair of wheels 30, for example, castor wheels, as detailed above. The frame 22, in this extended position, is such that all of the paired wheels 28-30 are in contact with the ground surface, to provide proper support to the frame and the operator thereon, as well as multidirectional mobility.

The base portion 24 is formed of oppositely disposed supports (support members) 32 that connect to cross bars 33. The cross bars 33 attach to and support a surface member 34. The surface member 34 is typically a board, or padded board, to support the operator comfortably.

The seat portion 26 is formed of oppositely disposed primary supports 42, that in turn, support typically paired oppositely disposed secondary supports 44. The secondary supports 44, including cross bars 44a, support a movable surface member 46, similar to the surface member 34. The movable surface member 46 and its secondary supports 44, are movable outward or cantilevered with respect to the seat portion 26 of the frame 22, as the secondary supports 44 are rotatably mounted to the primary supports 42, typically by pins 48, coupled with collapsible arms 50a, 50b (each formed of members 80a, 80b). The arms 50a, 50b are rotatably mounted to the primary supports 42 and the secondary supports 44 respectively by pins 51, 52. The movable surface member 46 functions as a seat potion of a chair, when the apparatus 20 is in an operative position, also known as the seat or second position, detailed below.

The seat portion 26 also typically includes cross-bars 53, similar to cross bars 33, that attach to and support a surface member 54. The surface member 54 is in accordance with surface members 34 and 46, and functions as a back support of a chair, when the apparatus 20 is in the seat position (or seat or chair orientation), detailed below.

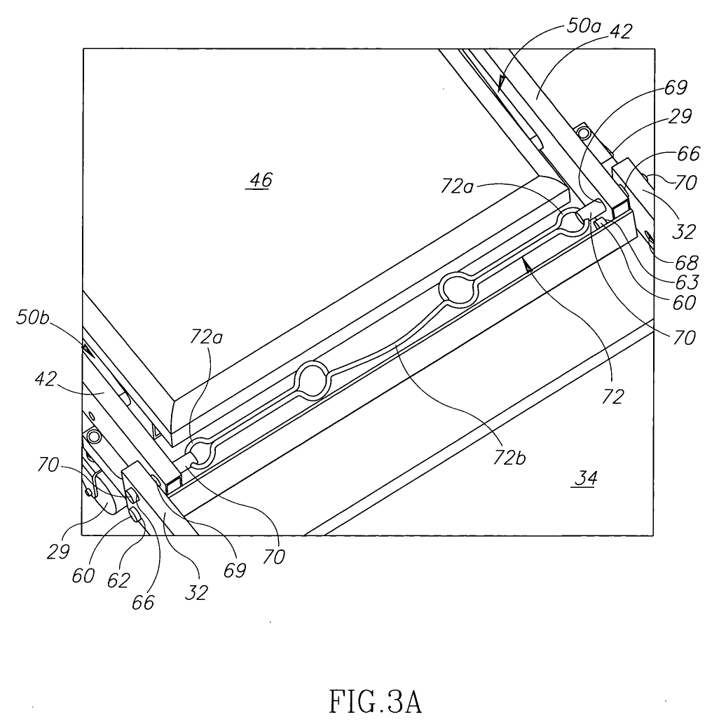

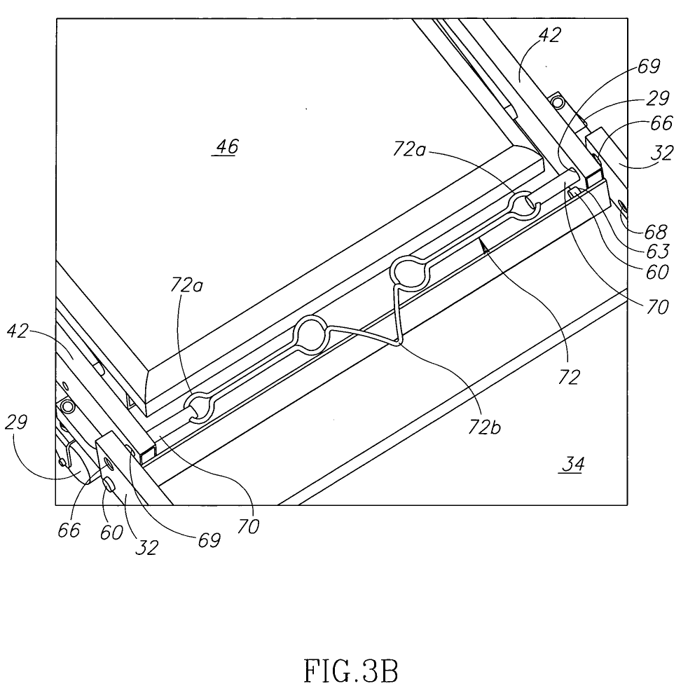

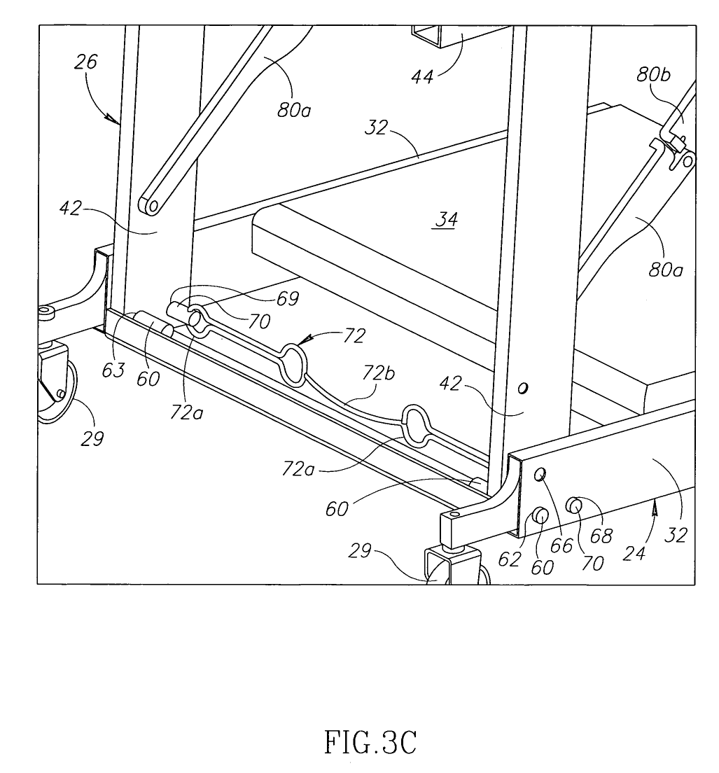

The base portion 24 and seat portion 26 are such that the base portion 24 typically receives the seat portion 26, as the distance between the supports 32 of the base portion 24 is greater than the distance between the primary supports 42 of the seat portion 26. This receipt is such that the base portion 24 and the seat portion 26 are joined by pins 60, that allow the base portion 24 and seat portion 26 of the frame 22 to be rotatable, in both the clockwise and counterclockwise directions, with respect to each other, between operative positions, the extended (first) position and the seat (second) position, and a storage (third) position, all positions detailed further below. The pins 60, are fitted into aligned openings 62, 63 (FIGS. 3A-3C) on the base portion supports 32 and the seat portion primary supports 42, respectively.

The supports 32 of the base portion 24 include additional openings 66, 68, while the primary supports 42 of the set portion 26 include an openings 69. The openings 66 and the openings 69 are configured to align, and receive movable locking pins 70 when the frame 22 is in an extended position (an operative position), and the openings 68 and openings 69 are configured to align, and receive the movable locking pins 70, when the frame 22 is in a seat position (another operative position).

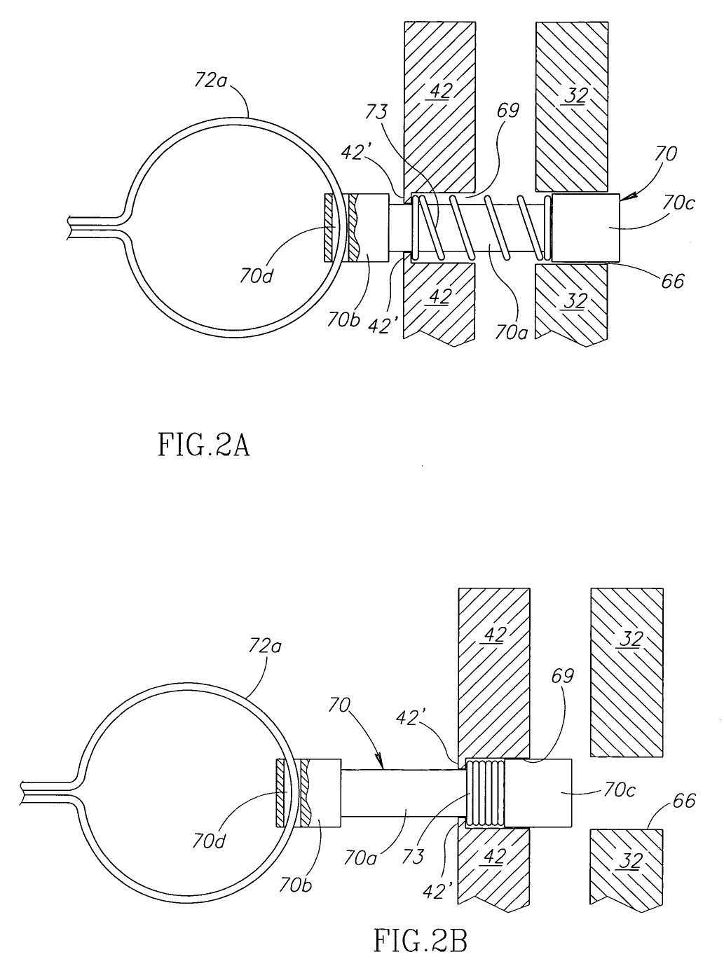

The locking pins 70 are disposed on opposite ends of a chain 72, with rings 72a, that connect to the each locking pin 70, respectively, as shown in FIG. 2A and 2B. There is a central portion 72b of the chain 72, that is typically pulled when movement of the locking pins 70, out of a locking engagement, is desired, to change the position of the frame 22 of the apparatus 20.

Turning to FIGS. 2A and 2B, a locking pin 70, representative of both of the locking pins 70, is shown in detail. The locking pins 70 are, for example, dumbbell-like in shape. Each pin 70 is spring loaded, as a spring 73 is positioned along a central portion 70a of the pin 70, between inner 70b and outer 70c portions of the pin 70. The inner 70b and outer 70c portions are of greater diameter than the central portion 70a, to retain the spring 73 along the pin 70.

The inner portion 70b of the pin 70, includes a bore 70d, through which the ring 72a of the chain extends therethrough. The pin 70 is also positioned such that shoulders 42′ on the primary support 42 extend to points proximate the surface of the central portion 70a of the pin 70, to serve as a stop surface for the spring 73, and limit travel (inward) of the pin 70. The shoulders 42′ also form an opening of lesser diameter than the outer portion 70c of the pin 70, and accordingly, should the spring 73 become loose or non-functional, inward travel of the pin 70 would remain limited. This is also the case for the inner portion 70b of the pin 70, and the shoulders 42′ would limit its outward travel.

The pin 70 is, for example, formed of two pieces, joined together, for example, in a screw-like manner. The pin 70 is typically of a metal material, such as stainless steel or the like, and the spring 73 is, for example, a metal coil spring.

The locking pins 70 are in movable between a locked position, where the spring 73 is in the extended position, its normal biased position, as shown in FIG. 2A, and an unlocked position, where the spring 73 is in a compressed position, as shown in FIG. 2B. By receiving the movable locking pins 70 through the respective aligned openings 66 (support member 32), 69 (primary support 42) and 68 (support member 32), 69 (primary support 42), the frame 22 is maintained in the respective extended (first) position or the seat (second) position, both operative positions, until a change in the position of the apparatus 20 is desired by the operator.

Turning also to FIG. 3A, the locking pins 70, with the spring 73 in the extended position, extend into aligned openings 66 and 69 on the support members 32 of the base member 24, and primary supports 42 of the seat member 26, respectively. These locking pins 70, when in the aligned openings 66, 69, of both the base portion supports 32 and the seat portion primary supports 42, respectively, retain the frame 22 of the apparatus 20 in the extended position, and prevent movement from this position.

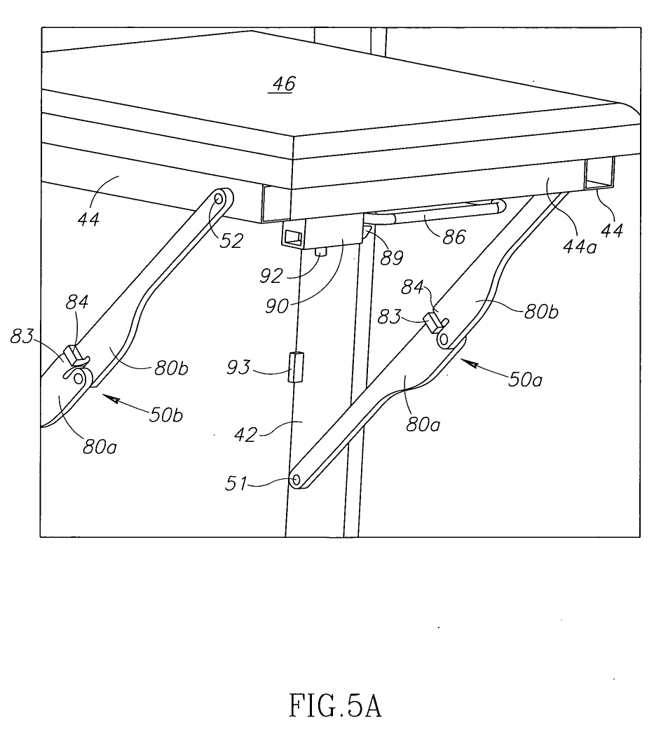

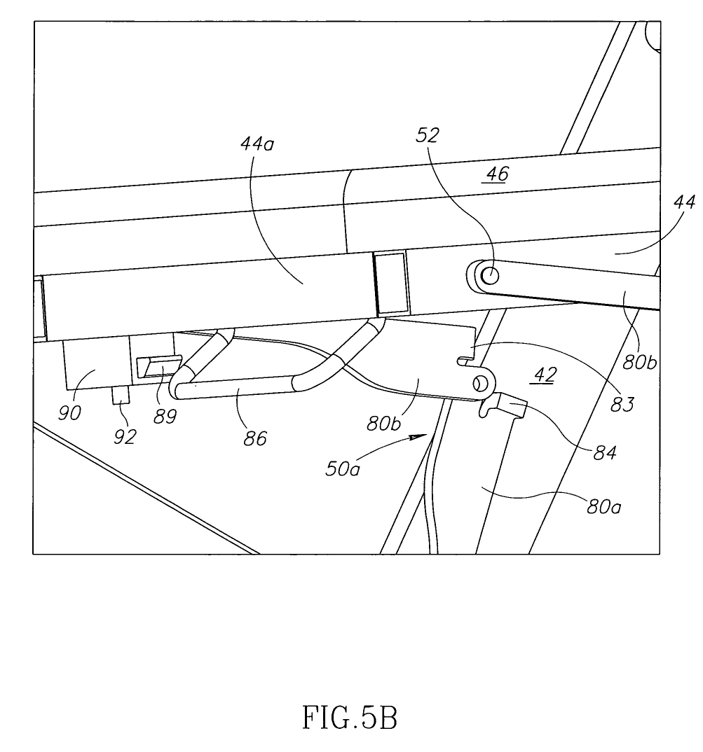

Turning also to FIG. 3B, when movement of the base portion 24 with respect to the seat portion 26, of the frame 22 of the apparatus 20 is desired, to either the seat position (FIG. 3) (an operative position) in a clockwise rotation, or the storage position (FIG. 5), in a counterclockwise rotation, the chain 72 is pulled, typically at the center portion 72b. The pulling of the center portion 72b, changes the shape of the chain 72, shortening its length, such that the pins 70 are moved to from the locked position, where the spring 73 is in the extended position, as shown in FIG. 2A, to a position where the pins 70, specifically, the outer portions 70c thereof, have cleared the openings 66 of the support member 32, and the springs 73 is in the compressed position, as shown in FIG. 2B.

The seat portion 26 of the frame 22 may now be rotated with respect to the base portion 24 of the frame 22. If the rotation is clockwise, the apparatus 20 will be moved to the seat position, an operative position, and if the rotation is counterclockwise, the apparatus 20 will be moved to the storage position.

FIG. 3C shows the apparatus 20 in the seat position. The chain 72 has returned to its original length, and the pins 70 are in aligned openings 68, on the support members 32, and 69 on the primary supports 42, respectively. The springs 73 of the pins 70 have returned to their extended or relaxed positions. The apparatus 20 is now locked in the seat (second) position (an operative position), where the base member 24 is typically perpendicular or approximately perpendicular with the seat member 26.

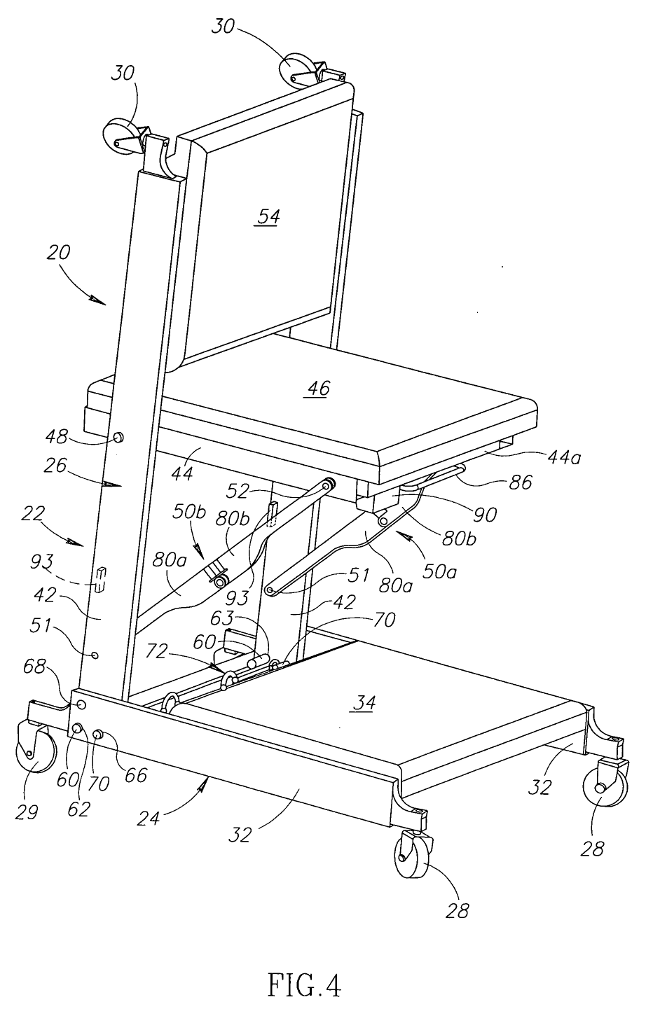

Turning now also to FIG. 4, with the seat position attained, the surface member 46 is now pulled outward, rotating counterclockwise about the pins 48 on the primary support members 42. This rotation continues until the arm members 80a (attached to the primary supports 42) and 80b (attached to a handle 86 through the secondary supports 44), of the arms 50a, 50b, become coaxial to each other and lock. When locking occurs, the surface member 46 is typically, and at least approximately, perpendicular to the surface member 54, and is locked securely in place, to support the operator in a sitting position.

As shown in detail in FIG. 5A, the locking between the arm members 80a, 80b is achieved as an inwardly bent flange 83 on the arm members 80a, abuts an outwardly bent flange 84 on the arm members 80b. Movement of the arm members 80a, 80b is further prevented, as a handle 86 is constrained, between a cross bar 44a and a tongue 89. The tongue 89 is typically spring loaded such that its normal position is outward from the spring box 90.

As shown in FIG. 5B, when returning the surface member 46 to its inward position, the tongue 89 may be moved inward, into the spring box 90, to clear the handle 86, by pressing the button 92 inward, toward the spring box 90. The tongue 89 clears the handle 86, such that the handle 86 is now free to be moved downward (rotated clockwise, this movement, moving the arm member 80a, 80b out of their coaxial alignment. The surface member 46 now rotates clockwise about the pins 48, until the surface member 46 is substantially coplanar, and typically coplanar with the primary supports 42. The arm members 80a have now collapsed to a point where they abut flanges 93 on the primary supports 42, limiting any further movement (clockwise rotation).

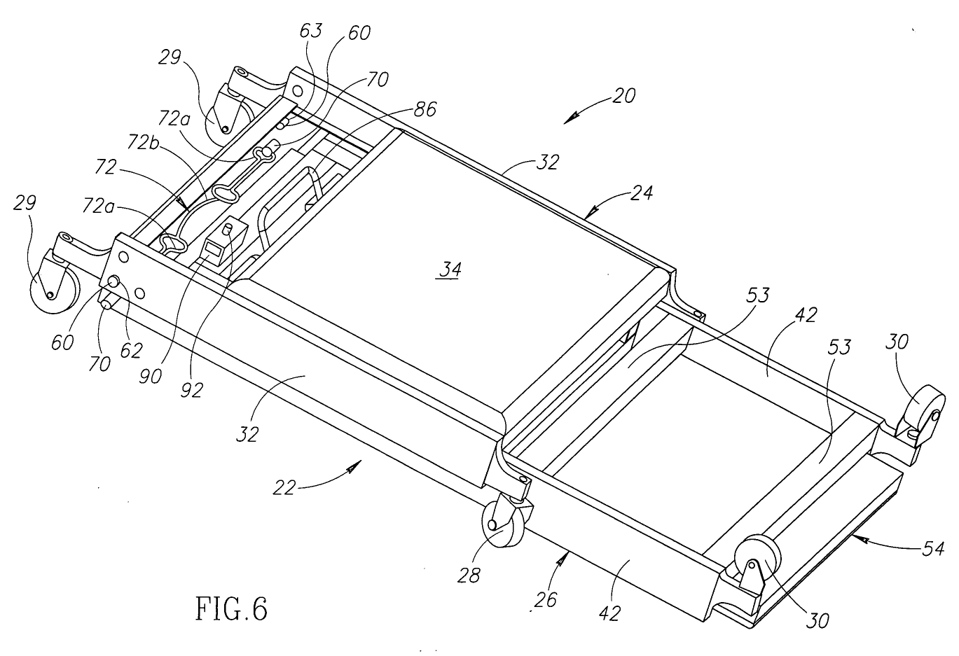

Turning back to FIG. 3C, should it be desired to return to the extended position (an operative position) or the storage position, the chain 72 is pulled, such that its length is shortened, moving the springs 73 of the pins 70 from the extended or relaxed position to the compressed position, such that the pins 70 move out of the openings 68 of the support members 32 of the base portion 24 of the frame 22. The seat portion 26 is now rotatable counterclockwise, and movable to either the extended position (FIG. 1) or the storage position, as shown in FIG. 6.

In this storage or third position, the seat portion 26 rests under the base portion 24, such that the base portion 24 and the seat portion 26 are typically parallel to each other. The base portion 24 is at an elevation sufficiently high enough such that with the moveable portion 26 under the base portion 24, the ground is still cleared by the wheels 28, 29, such that the apparatus 20 can roll along the ground surface, free of obstructions.

While preferred embodiments of the disclosed subject matter have been described, so as to enable one of skill in the art to practice the disclosed subject matter, the preceding description is intended to be exemplary only. It should not be used to limit the scope of the disclosure, which should be determined by reference to the following claims.

What is claimed is:

1. A transformable creeper comprising:
a frame including a first portion and a second portion, the first portion and the second portion joined together for being rotatable with respect to each other, and rotatable between a first position, where the first portion and the second portion are at least substantially coplanar to each other, a second position, where the first portion and second portion are at least substantially perpendicular to each other, and a third position, where the first portion and the second portion are at least substantially parallel to each other;
a support surface coupled to the first portion of the frame; and,
at least one support surface coupled to the second portion of the frame, the at least one support surface movable outward from the second portion to define a seat for supporting an operator, when the frame is in the second position.

2. The creeper of claim 1, additionally comprising:
at least a plurality of paired wheels coupled to the first portion of the frame; and,
at least one wheel coupled to the second portion of the frame.

3. The creeper of claim 2, wherein the at least one wheel includes two wheels.

4. The creeper of claim 1, wherein the at least one support surface coupled to the second portion of the frame includes a first support surface to define the seat, and a second support surface joined to the second portion to define a back panel for the first support surface, when the first support surface defines a seat.

5. The creeper of claim 4, wherein the first support surface is rotatably mounted to the second portion of the frame so as to be cantilevered with respect to the second potion of the frame when pulled out from the second portion of the frame to define the seat.

6. The creeper of claim 1, wherein the first portion includes a first set of openings and a second set of openings, and the second portion includes a set of openings, the second portion set of openings for aligning with the first set of openings when the first portion and the second portion are in the first position, and, the second portion set of openings for aligning with the second set of openings when the first portion and the second portion are in the second position, the sets of openings supporting locking pins movable therein.

7. The creeper of claim 6, additionally comprising:
a spring mechanism with locking pins at the ends of the spring mechanism for moving between an extended position, where the locking pins extended through the second portion set of openings and at least one of the first set of openings or the second set of openings of the first portion, to retain the apparatus in the first position or the second position, and a retracted position, where the locking pins are clear of the first set of openings and the second set of openings of the first portion, allowing the first portion and the second portion to be moved with respect to each other.

8. A transformable creeper comprising:
a first piece defining a base;
a second piece including a movable portion that is movable into at least one orientation defining a seat; and
the first piece and the second piece are rotatably mounted with respect to each other, and movable between a first position, where the first piece and the second piece are at least substantially coplanar to each other, and a second position, where the first piece and the second piece are at least substantially perpendicular to each other, the second position such that the movable portion is movable into the at least one orientation defining a seat.

9. The creeper of claim 8, wherein the first piece and the second piece are rotatably mounted with respect to each other, and movable to a third position, where the first piece and the second piece are at least substantially parallel to each other.

10. The creeper of claim 9, wherein the first piece includes a plurality of wheels.

11. The creeper of claim 9, wherein the second piece includes a plurality of wheels.

12. The creeper of claim 10, wherein the plurality of wheels includes four wheels.

13. The creeper of claim 12, wherein the second piece includes two wheels.

14. The creeper of claim 13, wherein the movable portion is rotatably attached to the second piece and is supported by the second piece in a cantilevered arrangement.

15. The creeper of claim 13, wherein the first piece includes a first set of openings and a second set of openings, and the second piece includes a set of openings, the second piece set of openings for aligning with the first set of openings when the first piece and the second piece are in the first position, and, the second piece set of openings for aligning with the second set of openings when the first piece and the second piece are in the second position, the sets of openings supporting locking pins movable therein.

16. The creeper of claim 15, additionally comprising:
a spring mechanism with locking pins at the ends of the spring mechanism for moving between an extended position, where the locking pins extended through the second piece set of openings and at least one of the first set of openings or the second set of openings of the first piece, to retain the apparatus in the first position or the second position, and a retracted position, where the locking pins are clear of the first set of openings and the second set of openings of the first piece, allowing the first piece and the second piece to be moved with respect to each other.

17. A transformable creeper comprising:
a first piece defining a base;
a second piece including a movable portion that is movable into at least one orientation defining a seat; and
the first piece and the second piece are rotatably mounted with respect to each other, and movable between at least one operative position and a storage position, where the first piece is at least substantially parallel to the second piece.

18. The creeper of claim 17, wherein the first piece and the second piece are rotatably mounted with respect to each other such that the at least one operative position includes, a first position, where the first piece and the second piece are at least substantially coplanar to each other, and a second position, where the first piece and the second piece are at least substantially perpendicular to each other, the second position such that the movable portion is movable into the at least one orientation defining a seat.

19. The creeper of claim 18, wherein the first piece includes a plurality of wheels for supporting the first piece as the base with respect to a surface, and the second piece includes a plurality of wheels for supporting the second piece on the ground surface in cooperation with the plurality of wheels of the first piece.

20. The creeper of claim 18, wherein the movable portion is rotatably attached to the second piece and is supported by the second piece in a cantilevered arrangement.

21. The creeper of claim 20, wherein the first piece includes a first set of openings and a second set of openings, and the second piece includes a set of openings, the second piece set of openings for aligning with the first set of openings when the first piece and the second piece are in the first position, and, the second piece set of openings for aligning with the second set of openings when the first piece and the second piece are in the second position, the sets of openings supporting locking pins movable therein.

22. The creeper of claim 21, additionally comprising, a spring mechanism with locking pins at the ends of the spring mechanism for moving between an extended position, where the locking pins extended through the second piece set of openings and at least one of the first set of openings or the second set of openings of the first piece, to retain the apparatus in the first position or the second position, and a retracted position where the locking pins are clear of the first set of openings and the second set of openings of the first piece, allowing the first piece and the second piece to be moved with respect to each other.

23. A method for operating a transformable creeper comprising:
providing a transformable creeper comprising:
a first piece defining a base;
a second piece including a movable portion, that is movable into at least one orientation defining a seat; and
the first piece and the second piece are rotatably mounted with respect to each other, and movable between a first position, where the first piece and the second piece are at least substantially coplanar to each other, and a second position, where the first piece and the second piece are at least substantially perpendicular to each other; and,
moving the first piece and the second piece into an at least substantially coplanar orientation with respect to each other, such that the creeper is in the first position.

24. The method of claim 23, additionally comprising:
moving the first piece and the second piece into an at least substantially perpendicular orientation with respect to each other such that the creeper is in the second position.

25. The method of claim 24, additionally comprising:
moving the movable portion of the second piece into an orientation defining a seat.

26. A method for operating a transformable creeper comprising:
providing a transformable creeper comprising:
a first piece defining a base;
a second piece including a movable portion that is movable into at least one orientation defining a seat; and
the first piece and the second piece are rotatably mounted with respect to each other and movable between at least one operative position and a storage position, where the first piece is at least substantially parallel to the second piece; and,
moving the second piece with respect to the first piece between the storage position and the at least one operative position.

27. The method of claim 26, wherein the at least one operative position includes the first piece and the second piece oriented so as to be substantially coplanar to each other for supporting an operator in a lying position.

28. The method of claim 26, wherein the at least one operative position includes the first piece and the second piece oriented so as to be substantially perpendicular to each other.

29. The method of claim 28, additionally comprising:
moving the movable portion of the second piece into an orientation defining a seat.
